(19) United States
(12) Patent Application Publication
(10) Pub. No.: US 2024/0210527 A1
(43) Pub. Date: Jun. 27, 2024

(54) LIDAR SYSTEM WITH MULTIPLE DETECTOR CHANNELS

(71) Applicant: Luminar Technologies, Inc., Orlando, FL (US)

(72) Inventors: Daniel Aaron MOHR, St. Paul, MN (US); Daniel Joseph KLEMME, Robbinsdale, MN (US)

(21) Appl. No.: 18/393,201

(22) Filed: Dec. 21, 2023

Related U.S. Application Data
(60) Provisional application No. 63/477,118, filed on Dec. 23, 2022.

(51) Int. Cl. G01S 7/481; G01S 7/4861

(52) U.S. Cl. CPC G01S 7/4816; G01S 7/4817; G01S 7/4861

(57) ABSTRACT

Implementations described and claimed herein include a device with a rotating polygon scanner configured to deflect light reflected from one or more distant objects towards a lens configured to focus the reflected light, and a detector chip including a plurality of detector channels, each detector channel including a photodiode configured to receive the focused light from the lens and a local oscillator, wherein the local oscillator on each of the plurality of detector channel has a power level that is different than power level of the local oscillator of the other of the plurality of detector channels.

### CROSS-REFERENCE TO RELATED APPLICATIONS

This application is a non-provisional application based on and takes priority from pending U.S. provisional application Ser. No. 63/477,118, entitled “Lidar System With Multiple Detector Channels,” which was filed on Dec. 23, 2022. The disclosure set forth in the referenced application is incorporated herein by reference in its entirety.

### BACKGROUND

Light detection and ranging (LIDAR) is a technology that measures a distance to an object by projecting a laser toward the object and receiving the reflected laser. In various implementation of LiDAR systems, a light source illuminates a scene. The light scattered by the objects of the scene is detected by a photodetector or an array of photodetectors. By measuring the time it takes for light to travel to the object and return from it, the distance may be calculated. A LIDAR system may use a number of different ranging methods, including pulsed time of flight, phase modulation, and frequency modulation.

### SUMMARY

Implementations described and claimed herein include a device with a rotating polygon scanner configured to deflect light reflected from one or more objects towards a lens configured to focus the reflected light, and a detector chip including a plurality of detector channels, each detector channel including a photodiode configured to receive the focused light from the lens and a local oscillator, wherein the local oscillator on each of the plurality of detector channel has a power level that is different than power level of the local oscillator of the other of the plurality of detector channels.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates an example configuration of a LiDAR system using a rotating polygon scanner configured to induce angle offset between the light reflected from one or more distant objects and multiple receive channels.

FIG. 2 illustrates an example configuration of a LiDAR system detector with tapered local oscillator power by detector channel.

FIG. 3 illustrates an example illustration of a LiDAR system detector with electronic switching structure to change sets of channels being processed.

FIG. 4 illustrates an example configuration of a LiDAR system detector with an alternative electronic switching structure to change sets of channels being processed including voltage adders.

FIG. 5 illustrates an example processing system that may be useful in implementing the technology described herein.

### DETAILED DESCRIPTIONS

In a laser detection and ranging (LiDAR) systems, the number of points per second that a given laser source can provide to a point cloud is typically limited by the maximum range said LiDAR system seeks to address. This is due to the fact that light takes a finite time to travel to the target and back. If the round-trip travel time of light to the LiDAR's maximum range is given by tₘₐₓ, then any pulse repetition rate that is less than tₘₐₓ introduces an ambiguity, as it will not be clear if the earlier pulse is returning from a distant target, or the later pulse is returning from a nearby target. It is generally true, then, that for a single source in a LiDAR system to generate points at a repetition rate greater than tₘₐₓ, it must have some way to disambiguate between pulses that were fired within the time tₘₐₓ.

Furthermore, in LiDAR systems, there is often a very large range of signals that need to be detectable by the embedded systems and electronics. Often these systems send out a powerful pulse of light which travels until it hits a target, and the target scatters the light in all directions. The LiDAR system then detects only a fraction of this scattered light power that travels back to its detection optics. In this case, the power of the detected optical pulse it proportional to 1/R\hat{ }2, where R is the distance to the target. In a typical LiDAR system, the common target may be from 1 meter to 300 meters, resulting in a dynamic range for the power of approximately 10e⁵. Furthermore, it is often desirable to detect targets at long ranges with reflectivity as low as 10%, while also detecting targets that are 100% reflective, which further increases the dynamic range by a factor 10 to approximately 10e⁶. Additionally, in many applications it is not uncommon for surfaces to be retroreflectors, which directly reflect the light back to the system rather than scattering in all directions. This can introduce extremely high power returns. Even not considering retroreflectors, the 10e⁶ dynamic range needed in a LiDAR system can be difficult to process.

Such processing of the scattered/reflected light signal is further complicated in a LiDAR system using rotating scanner such as the implementations disclosed herein. Specifically, the LiDAR system disclosed herein may include an optomechanical scanner. For example, the optomechanical scanner may be a rotating polygon scanner with mirror surfaces on its side that reflects laser beam from a laser source towards the targets and the scattered/reflected light signals from the targets towards detectors. Alternatively, the rapid optomechanical scanner may be fast galvo scanner, a micro-electronic mechanical systems (MEMS) scanner, a rotating prism scanner, etc. In a rapid opto-mechanical scanner, such as a spinning polygonal mirror, it may not be feasible to stop or even slow down the scanner while the pulse is in flight. Thus, the rotational momentum of the scanner implies that its rotational motion continues when the optical pulse is in flight. The optical pulse may take up to a few micro-seconds to travel from the light source to the target and back to the detector, such rotation of the polygon scanner results in its mirror surface pointing in a slightly different direction when a light pulse returns vs. when it was emitted from the laser source.

As a result, the scanner will reflect a pulse returning to the system at a different angle to when it was transmitted. Often this angle difference is fractions of a degree, and it increases linearly with distance to the target that a pulse reflects from. When this pulse is put upon a collection optic such as a lens, the action of said optic will be to focus the pulse onto a detector. However, the lens also transforms the small angular offset into a positional offset on the detector face. This positional offset becomes larger as the range to a target increases. The magnitude of this positional offset is usually a few 10's to potentially a few 100's of microns in typical embodiments, and the magnitude may depend on one or more parameters such as the lens focal length, scanning speed, and target distance.

LiDAR can use ultraviolet, visible, or near-infrared sources to sense, image, identify, or map objects. In some cases, the sensor uses coherent detection, where a portion of the energy from the laser is separated and made to interfere optically with the energy reflected by the target. In the case of a coherent detection scheme, LiDAR loses signal if the target is farther than half of the coherence length of the light source. In coherent LiDAR systems, the scanner-induced angle offset makes operation difficult. Direct-detection LiDAR systems such as time-of-flight can simply use a detector whose size is on the order of the positional offset induced by the beam. This would result in more noise on the detector, but the overall system remains feasible. However, because coherent LiDAR relies on the precise interference of a local oscillator laser beam with the returning laser beam, a coherent LiDAR system cannot tolerate positional offset that is much greater than the size of a single mode, which is often on the order of the wavelength of light used, or only a few microns. Because of this, it is important to manage the effects of the positional offset of the light in coherent LiDAR systems.

Implementations disclosed herein provide a method to counteract the effect of positional offset induced by the rotating scanner by using multiple spatially separated detector channels on a detector chip to capture the light as it scans across the face of the detector chip. Furthermore, each channel has its own local oscillator incident on it such that as the receiver (Rx) light is scanned across the face of a detector, it will mix with completely separate local oscillators and generate electrical current on separate photodiodes of the detector. In such a system, the signal from these separate photodiodes may have to be digitized in order to perform the mathematical operations necessary to generate range and/or velocity signals.

To reduce the number of analog to digital converters (ADCs) needed, some of photodetectors in the disclosed system are electrically tied together such that their signals are added and the cumulative signal is handled by a single ADC. This allows reducing the number of required ADCs to a number that is tolerable in a given application due to power/signal processing constraints. Adding multiple ADCs results in an increased noise floor on the detected signal. For example, N detectors together generates noise that is \sqrt{N} times larger than what is produced by a single detector. Therefore, to be able to detect targets at long range, it is desirable to minimize the number of detectors that are tied together on a signal processing chain.

The noise on a detector is shot noise limited such that the noise on the detector is proportional to local oscillator power on that detector. Therefore, higher local oscillator power on a detector results in higher signal as well as noise for that detector. Therefore, to further reduce the number of required ADCs, the implementations of the LiDAR system disclosed herein provides a method of tapering the power of the local oscillator arms on spatially separated detector channels such that the photodiodes on the detector channels can be tied together electrically with less impact to the system performance. Specifically, in the LiDAR system disclosed herein, the power of each of the various local oscillator arms is tapered such that the signal generated by the local oscillator that address longer ranges becomes stronger compared to the signal generated by the local oscillator that address shorter ranges.

Additionally, one implementation disclosed herein also provides an electronic switch that is configured to select output from one or more of the various spatially separated channels at a time to be input to an ADC. Another implementation disclosed herein provides a voltage adder circuit to add the signal output from adjacent spatially separated channels such that the cumulative output can be selected by the electronic switch to be input to the ADC. Another implementation disclosed herein may provide an optical switch that controls the path of one or more local oscillator modes directly to switch between detection channels. In such an implementation, only the detection channels with photodiodes that have local oscillator power on them contributes to both signal and/or noise.

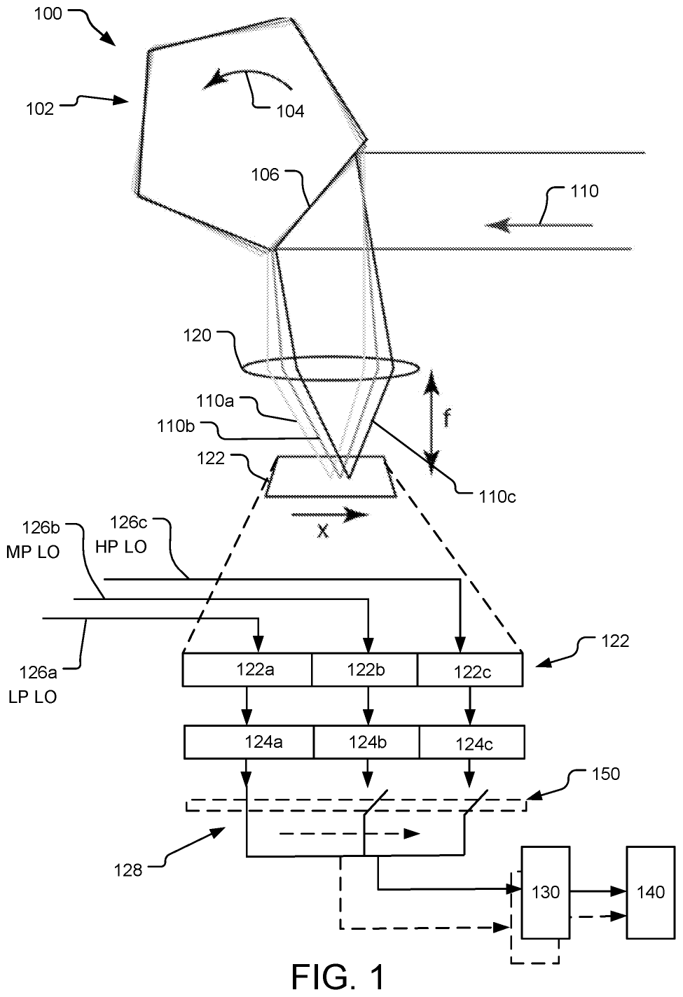

FIG. 1 illustrates a LiDAR system 100 using a rotating polygon scanner configured to induce angle offset between the light reflected from one or more distant objects and multiple receive channels. Specifically, the LiDAR system 100 includes a rotating polygon scanner 102 rotating around its axis in the direction 104. The light 110 reflected from targets at different instances in time may find a reflecting surface 106 of the scanner 102 to be slightly at a different angle. As a result the reflected light signal 110 that impinges on the surface 106 at moment a may result in being focused by a lens 120 as illustrated by focused light 110a. On the other hand, the reflected light signal 110 that impinges on the surface 106 at moment c, with moment a being different in time compared to moment c, may result in being focused by a lens 120 as illustrated by focused light 110c.

Thus, the rotational movement of the scanner 102 results in the reflected light beam 110 being focused at different points on the detector 122, thus allowing the light received at different times being disambiguated from each other. As the time for the reflected light 110 impinging on the scanner surface 106 depends on distance of the target that it is being reflected from, this disambiguation in effect allows disambiguating between reflected light being received from targets at different distances. Such lateral motion of the received light in the x direction on the detector depends on the various factors including focal length f of the lens 120, the time delay t experienced by the reflected light 110 in transit to and from the target, and rotational speed w of the scanner 102. For example, for f of 20 mm, w of 240π, and t of 2 μs, the lateral displacement may be given by x=60.3 μm.

The detector 122 may include an array of spatially separated detector channels 122a, 122b, 122c with each channel including a photodiode, a local oscillator, and other components. The photodiodes of the detector channels 122a, 122b, 122c may be avalanche photodiodes (APDs). However, in alternative implementations, other types of photodiodes may be used and the selection of the type of photodiodes may depend on the frequency of the transmitted light as well as the frequency of the light received at the detector 122. In one implementation, a signal processing chain tracks which APD array produces a signal to provide a coarse estimate to the range of the target and in so doing disambiguates which pulse produced the signal.

In the illustrated implementation, the detector 122 may be configured to include the detector channels 122a, 122b, 122c such that at as a result of the lateral movement x, the reflected light 110a from a shorter distance target is received on the photodiode of the detector channel 122a, the reflected light 110b from a medium distance target is received on the photodiode of the detector channel 122b, whereas the reflected light 110c from a longer distance target is received on the photodiode of the detector channel 122c. The size and position of the photodiodes of the detector channels 122a, 122b, 122c laterally along the x-direction is determined by the range to the targets from the scanner 102, the scanning speed of the scanner 102, and the effective focal length of the collection lens 120.

In one implementation, the multiple spatially separated detector channels 122a, 122b, 122c on a detector chip may be configured such that the light received on each of the spatially separated detector channels 122a, 122b, 122c mixes with the signal from the local oscillator of the respective spatially separated detector channels 122a, 122b, 122c. In the illustrated implementation, the local oscillator on detector channel 122a is configured to generate low power local oscillator signal 126a, the local oscillator on detector channel 122b is configured to generate medium power local oscillator signal 126b, and the local oscillator on detector channel 122c is configured to generate high power local oscillator signal 126c. In other words, each of the oscillator signals 126a, 126b, and 126c, are different from each other but tapered along the x direction.

Thus, the light signal 110a from lower range targets is mixed with low power LO signal 126a, the light signal 110b from medium range targets is mixed with medium power LO signal 126b, and the light signal 110c from far range targets is mixed with high power LO signal 126c. As a result, the light signal 110a from the lower range targets is amplified by the lowest amount compared to the amplification of the other light signals 110b and 110c. As a result, the noise level in the signal output from the detector channel 122a is low. On the other hand, the light signal 110c from the far range targets is amplified by the highest amount compared to the amplification of the other light signals 110a and 110b.

As a result, the noise level in the signal output from the detector channel 122c is high. As a result of this configuration, the excess signal to noise ratio (SNR) in the output signal generated by the detector channel 122a processing the light signal 110a from the low range targets is spread across the output signal generated by the detector channel 122b processing the light signal 110b from the medium range targets and the output signal generated by the detector channel 122c processing the light signal 110c from the far range targets. Thus, in effect the tapered LO power across the detector channels 122a, 122b, and 122c results in tuning of the SNR of each of these channels relative to the SNR of the other channels. In one implementation, the LO powers on the detector channels 122a, 122b, and 122c may be adjusted by a controller in real time.

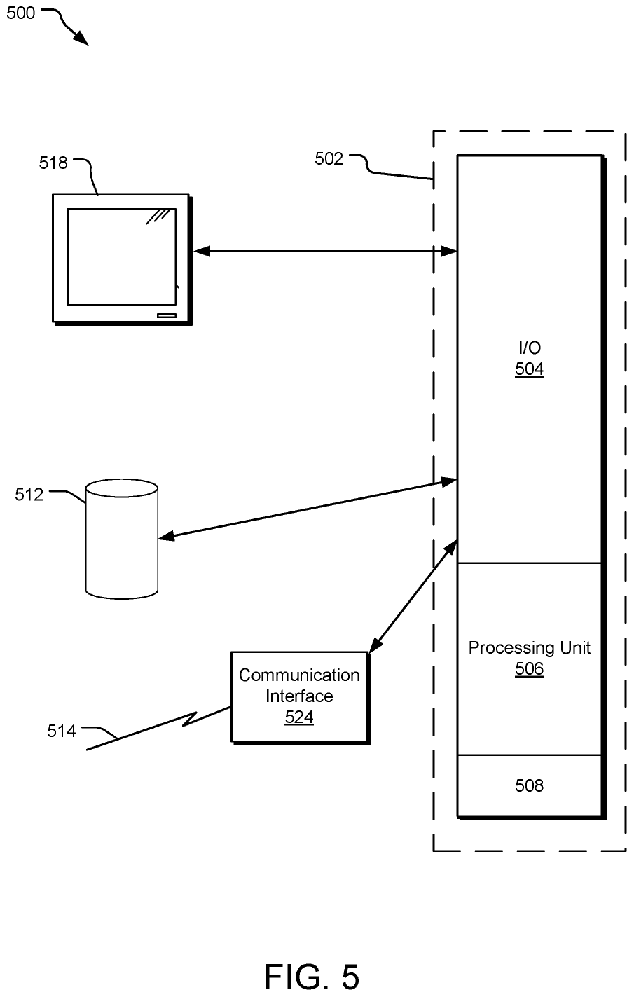

The signals output from the channels 122a, 122b, and 122c are input into amplifiers 124a, 124b, and 124c. In one implementation, the amplifiers 124a, 124b, and 124c may be transimpedance amplifiers (TIAs). Subsequently, the output from the amplifiers 124a, 124b, and 124c may be selectively output by an electronic switch 128 to an analog to digital convert (ADC) 130. For example, the electronic switch 128 may over time select output from a selected individual or group of channels 122a, 122b, and 122c. In an alternative implementation, more than one ADC may be provided with the electronic switch 128 interleaving output from the channels 122a, 122b, and 122c such that output from even channels go to a first ADC 130 and the output from odd channels go to a second ADC 130. Such configuration allows full signal detection no matter the signal's exact return path. The interleaving of the output from the channels 122a, 122b, and 122c may be done serially such that when the output is switched in to the first ADC 130, the second ADC 130 is turned-off and vice-versa. Such switching off of the ADCs 130 improves the SNR of the ADCs 130. Subsequently the digital output of the ADC 130 is input to a digital signal processing (DSP) circuit 140 such as the processor disclosed below in FIG. 5 to determine the range of the targets related to the reflected signals 110a, 110b, and 110c.

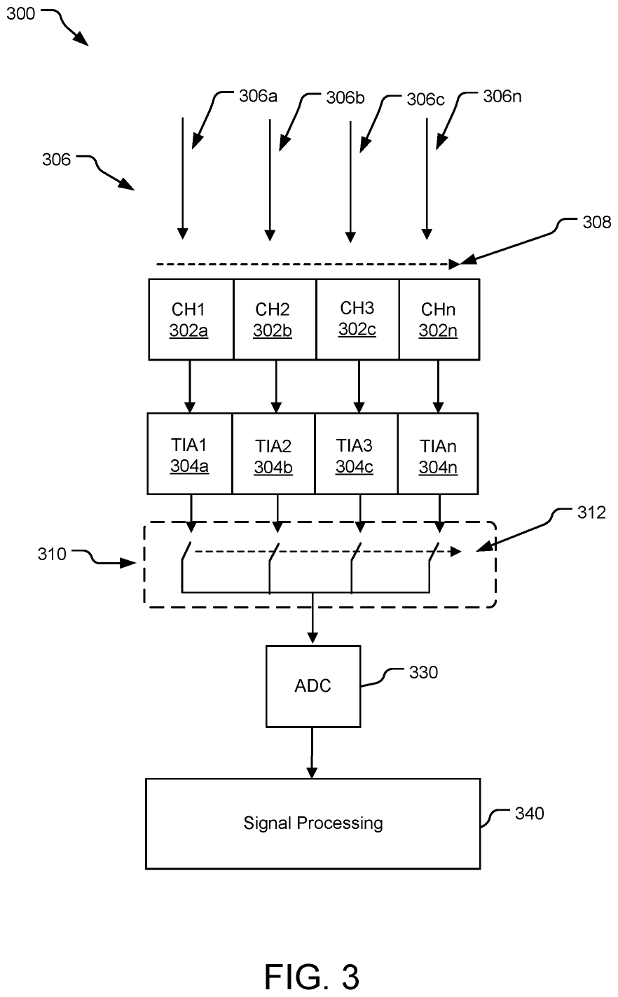

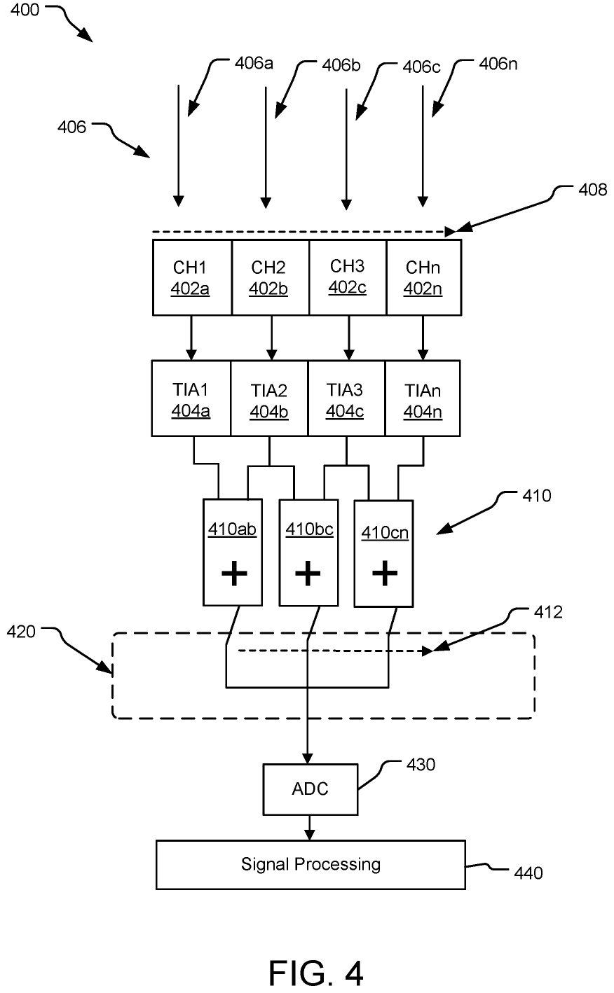

In an alternative implementation, an adder circuit 150 may be configured between the TIAs 124a, 124b, and 124c and the electronic switch 128 to selectively add output from some of the channels 122a, 122b, and 122c. For example, the output from odd of the channels 122a, 122b, and 122c may be added by the adder 150 over a first time period and the sum may be output to the electronic switch 128. Subsequently, the output even of the channels 122a, 122b, and 122c may be added by the adder 150 over a second time period and the sum may be output to the electronic switch 128. The functioning of the adder 150 is disclosed in further detail below in FIGS. 3 and 4.

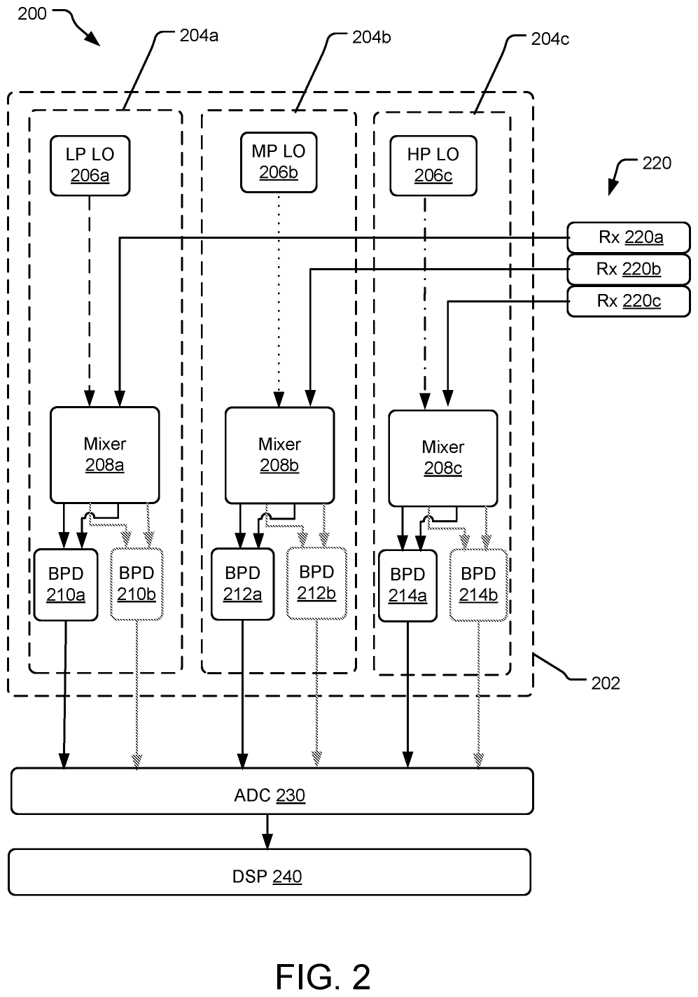

FIG. 2 illustrates a LiDAR system detector 200 with tapered local oscillator powers by detector channel. The detector 200 includes a chip 202 that implements a number of detector channels. For example, in the illustrated implementation, the chip 202 includes three detector channels 204a, 204b, and 204c (together referred to as detector channels 204), each of the detector channels 204 is configured to process a light signal received from targets of the LiDAR system. For example, the LiDAR system detector 200 may be configured with a LiDAR system having a rotating polygon scanner that scans a range of targets such that the detector 200 has to detect a large range of signals.

The detector channels 204 may be spatially separated on the chip 202. Each of the detector channels 204 includes various electronic components to receive and process light signal from LiDAR system targets. Specifically, the detector channel 204a includes a low power local oscillator (LP LO) 206a, the detector channel 204b includes a mid power local oscillator (MP LO) 206b, and the detector channel 204c includes a high power local oscillator (HP LO) 206c. For example, in one implementation, the power level on the LP LO 206a may be 250 microwatts, the power level on the MP LO 206b may be 500 microwatts, and the power level on the HP LO 206c may be 1 milliwatt. Furthermore, each of the detector channels 204 includes mixers 208a, 208b, and 208c, (together referred to as mixers 208) respectively, to mix a light signal received from a receiver 220 with the LO signal from their respective LO. Each of the mixers 208 may be 90 degree hybrid mixers that splits an input signal into two paths with a 90 degree phase shift between them or to combine two signals while maintaining high isolation between them. For example, the two output signals from the mixer 208a are input into BPDs 210a and 210b, the two output signals from the mixer 208b are input into BPDs 212a and 212b, and the two output signals from the mixer 208c are input into BPDs 214a and 214b.

Each of the detector channels 204 also includes balanced photodetectors to receive the output from the mixers 208 and to generate output electrical signals that may be input to an ADC 230. The output of the ADC 230 may be processed by a digital signal processing (DSP) unit to determine the range information about various targets of the LiDAR system.

The receiver 220 includes a number of optoelectronic sensors that may couple received light from LiDAR system targets to the detector channels 204. For example, the receiver 220 is illustrated as having three receive channels 220a, 220b, and 220c. The receive channels 220a, 220b, and 220c are serially separated from each other in that as the optical scanner of the LiDAR system rotates, the angle lag of the scanner causes the return light to scan across over time. In the illustrated implementation, the receive channel 220a may correspond to the light signal received from short-range targets, the receive channel 220b may correspond to the light signal received from mid-range targets, and the receive channel 220c may correspond to the light signal received from far-range targets.

The strength of the light signal received at the receiver 220 depends on the distance of the targets. Therefore, the light signal received at the receiver channel 220a is stronger compared to light signals at receiver channel 220b and 220c, wherein the light signal received at the receiver channel 220c is weaker compared to light signals at receiver channel 220a and 220b. Subsequently, the low power light signal received at receiver channel 220c is coupled with high power LO signal from HP LO 206c, which results in higher amplification of the low power light signal received at receiver channel 220c. The high power light signal received at receiver channel 220a is coupled with low power LO signal from LP LO 206a, which results in lower amplification of the high power light signal received at receiver channel 220a. Finally, the mid power light signal received at receiver channel 220b is coupled with mid power LO signal from MP LO 206b, which results in medium amplification of the medium power light signal received at receiver channel 220b.

As a result of this configuration, the excess signal to noise ratio (SNR) in the output signal generated by the detector channel 204a processing the light signal 220a from the low range targets is spread across the output signal generated by the detector channel 204b processing the light signal 220b from the medium range targets and the output signal generated by the detector channel 204c processing the light signal 220c from the far range targets. Thus, in effect the tapered LO power across the detector channels 204 results in tuning of the SNR of each of these channels relative to the SNR of the other channels. In one implementation, the LO powers on the detector channels 204 may be adjusted by a controller in real time.

FIG. 3 illustrates a LiDAR system detector 300 with electronic switching structure to change sets of channels being processed. The detector 300 includes four detector channels 302a-302n that receives return light signal 306 from targets of the LiDAR system. The LiDAR system may employ a rotating polygon scanner. Specifically, the angle lag of the rotating polygon scanner causes the return light signal 306 to scan across over time as illustrated by 308. The detector channels 302 are spatially separated such that each of the channels 302a-302n receives return light signal 306 at different times. For example, a return light signal 306a received at the detector channel 302a may be from targets that are at a closer distance, whereas the return light signal 306n received at the detector channel 302n may be from targets that are at a longer distance.

The detector channels 302 may include various components such as local oscillators, mixers, photodiodes, etc., to process the return light signal 306 and to generate electrical output signal. In one implementation, a series of amplifiers 304a-304n may couple the electrical signal output from the detector channels 302. For example, the amplifiers 304 may be transimpedance amplifiers. As the detector channels 302 receives return light signal 306 that is serially separated over a time period, the outputs from the amplifiers 304 may also be is serially separated from each other over a time period. Thus, at any one point in time only one of the amplifiers 304 has output signal that is representative of the return light signal 306.

Therefore, an electronic switch 310 is used to serially select output from the amplifiers 304. The electronic switch 310 may be controlled such that it selects an output from amplifier 304a when the return light signal 306a is expected to be received at the detector channel 302a, selects an output from amplifier 304b when the return light signal 306b is expected to be received at the detector channel 302b, etc. Thus, in effect, the electronic switch 310 may serially select output from one of the amplifiers 304 as indicated by 312, which corresponds to the temporal receipt of return light signal 306 as indicated by 308.

As a result of providing the electronic switch 312 to selectively couple output from amplifiers 304 to the ADC 330, the number of ADC required by the LiDAR system is reduced. In an alternative implementation, the electronic switch 312 may be replaced by an optical switch. Furthermore, additional ADC's may also be added to interleave adjacent channels so that even channels go to one ADC and odd channels go to the other. Such interleaving enables full detection of the return light signal 306 no matter the exact return path of the return light signal 306.

FIG. 4 illustrates a LiDAR system detector 400 with an alternative electronic switching structure to change sets of channels being processed including voltage adders. The detector 400 includes four detector channels 402a-402n that receives return light signal 406 from targets of the LiDAR system. The LiDAR system may employ a rotating polygon scanner. Specifically, the angle lag of the rotating polygon scanner causes the return light signal 306 to scan across over time as illustrated by 408. The detector channels 402 are spatially separated such that each of the channels 402a-402n receives return light signal 406 at different times. For example, a return light signal 406a received at the detector channel 402a may be from targets that are at a closer distance, whereas the return light signal 406n received at the detector channel 402n may be from targets that are at a longer distance.

The detector channels 402 may include various components such as local oscillators, mixers, photodiodes, etc., to process the return light signal 406 and to generate electrical output signal. In one implementation, a series of amplifiers 404a-404n may be couple the electrical signal output from the detector channels 402. For example, the amplifiers 404 may be transimpedance amplifiers. As the detector channels 402 receives return light signal 406 that is serially separated over time, the outputs from the amplifiers 404 may also be serially separated over time from each other. Thus, at any one point in time only one of the amplifiers 404 has output signal that is representative of the return light signal 406.

Additionally, the output from the amplifiers 404 are input to voltage adders 410. The voltage adders 410 combines the signals from adjacent detector channels 402 so that when the return light signal 406 falls in between two adjacent spatially separated detector channels 402 and/or is partially on two adjacent detector channels, the output from the adjacent detector channels 402 is added together. This ensures that the output from adjacent detector channels 402 is handled by the same ADC 430.

An electronic switch 420 is used to serially select output from the voltage adders 410. The electronic switch 420 may be controlled such that it selects an output from voltage adders 410ab when the return light signal 406 is expected to be received at the detector channels 402a and 402b, selects an output from adder 410bc when the return light signal 406 is expected to be received at the detector channels 402b and 402c, etc. Thus, in effect, the electronic switch 420 may serially select output from one of the voltage adders 410 as indicated by 412, which corresponds to the temporal receipt of return light signal 406 as indicated by 408.

FIG. 5 illustrates an example processing system 500 that may be useful in implementing the described technology. The processing system 500 is capable of executing a computer program product embodied in a tangible computer-readable storage medium to execute a computer process. Data and program files may be input to the processing system 500, which reads the files and executes the programs therein using one or more processors (e.g., CPUs, GPUs, ASICs). Some of the elements of a processing system 500 are shown in FIG. 5 wherein a processing device 502 is shown having an input/output (I/O) section 504, a processing unit 506, and a memory section 508.

In some implementations, an operating system (not shown) may reside in the memory 508 and be executed by the processing unit 506. In other implementations, the processing unit 506 does not execute an operating system during nominal operations. One or more applications (not shown) may reside in the memory 508, such as applications that are implemented on the digital signal processing units 140, 240, 340, and 440 disclosed, respectively, in FIGS. 1-4. In various implementations, the processing unit 506 could be an application-specific integrated circuit (ASIC), digital signal processor (DSP), system on chip (SoC), central processing unit (CPU) of a general purpose computer, etc. In some implementations, the processing unit 506 comprises more than one processor. The processor(s) may be single core or multi-core processors. The processing device 502 may be a special purpose computing device, a conventional computer, a distributed computer, or any other type of processing device.

There may be one or more processing devices 502, such that the processing device 502 of the processing system 500 comprises a single processing unit 506, or a plurality of processing units. The processors may be single core or multi-core processors. The processing system 500 may be a conventional computer, a distributed computer, or any other type of computer. The described technology is optionally implemented in software loaded in memory 508, a storage unit 512, and/or communicated via a wired or wireless network link 514 on a carrier signal (e.g., Ethernet, 3G wireless, 5G wireless, LTE (Long Term Evolution)) thereby transforming the processing system 500 in FIG. 5 to a special purpose machine for implementing the described operations. The processing system 500 may be an application specific processing system configured for supporting the disc drive throughput balancing system disclosed herein.

The I/O section 504 may be connected to one or more user-interface devices (e.g., a keyboard, a touch-screen display unit 518, etc.) or a storage unit 512. Computer program products containing mechanisms to effectuate the systems and methods in accordance with the described technology may reside in the memory section 508 or on the storage unit 512 of such a system 500.

A communication interface 524 is capable of connecting the processing system 500 to an enterprise network via the network link 514, through which the computer system can receive instructions and data embodied in a carrier wave. When used in a local area networking (LAN) environment, the processing system 500 is connected (by wired connection or wirelessly) to a local network through the communication interface 524, which is one type of communications device. When used in a wide-area-networking (WAN) environment, the processing system 500 typically includes a modem, a network adapter, or any other type of communications device for establishing communications over the wide area network. In a networked environment, program modules depicted relative to the processing system 500 or portions thereof, may be stored in a remote memory storage device. It is appreciated that the network connections shown are examples of communications devices for and other means of establishing a communications link between the computers may be used.

In an example implementation, a storage controller, and other modules may be embodied by instructions stored in memory 508 and/or the storage unit 512 and executed by the processing device 502. Further, the storage controller may be configured to assist in supporting the RAID0 implementation. A RAID storage may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 508 and/or the storage unit 512 and executed by the processing device 502.

The processing system 500 may be implemented in a device, such as a user device, storage device, IoT device, a desktop, laptop, computing device. The processing system 500 may be a storage device that executes in a user device or external to a user device.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

The embodiments of the disclosed technology described herein are implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the disclosed technology. Accordingly, the logical operations making up the embodiments of the disclosed technology described herein are referred to variously as operations, steps, objects, or modules. Furthermore, it should be understood that logical operations may be performed in any order, adding, and omitting as desired, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A device comprising:
an optomechanical scanner configured to deflect light reflected from one or more objects towards a lens configured to focus the reflected light; and
a detector chip including a plurality of detector channels, each detector channel comprising:
a photodiode configured to receive the focused light from the lens, and
a local oscillator;
wherein the local oscillator on each of the plurality of detector channels has a power level that is different than power level of the local oscillator of the other of the plurality of detector channels.

2. The device of claim 1, wherein each of the detector channels is spatially separated from the other detector channels.

3. The device of claim 1, wherein the optomechanical scanner induces an angle offset between the light reflected from the one or more objects.

4. The device of claim 3, wherein each of the detector channels is configured to receive the focused light from the lens at a different angle offset induced by the optomechanical scanner.

5. The device of claim 1, wherein the power level of the local oscillators of the detector channels is tapered such that the power level of a local oscillator of the detector channel configured to receive light reflected from an object substantially near a short end of a range of the optomechanical scanner is lower than the power level of a local oscillator of the detector channel configured to receive light reflected from an object substantially near a far end of the range of the optomechanical scanner.

6. The device of claim 1, wherein each of the detector channels further comprises a mixer that is configured to mix the focused light from the lens at the detector channel with the local oscillator output signal.

7. The device of claim 6, wherein each of the detector channels further comprises a pair of balanced photodiodes (BPDs) configured to convert the output from the mixer into an electrical signal.

8. The device of claim 7, further comprising a switch configured to serially couple output from one of the detector channels with an analog to digital converter (ADC), wherein the switch may be at least one of an electronic switch and an optical switch.

9. The device of claim 8, further comprising a plurality of voltage adders wherein each of the plurality of voltage adders is configured to add the output signals related to adjacent detector channels.

10. The device of claim 8, wherein the switch is further configured to interleave the output from adjacent detector channels such that output from even numbered of the detector channels is coupled to a first ADC and the output from odd numbered of the detector channels is coupled to a second ADC.

11. A LIDAR system, comprising:
a scanner configured to deflect light reflected from one or more objects towards a lens configured to focus the reflected light, wherein the scanner is configured to induce an angle offset between the light reflected from one or more objects;
a detector chip including a plurality of detector channels, each of the detector channels comprising:
a photodiode configured to receive the focused light from the lens, and
a local oscillator;
an electronic switch configured to couple output from each of the detector channels with an analog to digital converter (ADC) in a serial manner.

12. The LiDAR system of claim 11, wherein the local oscillator on each of the plurality of detector channel has a power level that is different than power level of the local oscillator of the other of the plurality of detector channels.

13. The LiDAR system of claim 11, further comprising a plurality of voltage adders wherein each of the plurality of voltage adders is configured to add the output signals related to adjacent detector channels.

14. The LiDAR system assembly of claim 11, wherein the electronic switch is configured to interleave the output from adjacent detector channels such that output from even number of channels is coupled to a first ADC and the output from odd number of channels is coupled to a second ADC.

15. The LiDAR system of claim 11, wherein each of the detector channels is configured to receive the focused light at a different offset angle induced by the optomechanical scanner.

16. A device comprising:
a rotating polygon scanner configured to deflect light reflected from one or more objects towards a lens configured to focus the reflected light, wherein the rotating polygon scanner is configured to induce angle offset between the light reflected from the one or more objects; and
a detector chip including a plurality of spatially separated detector channels, each of the detector channels comprising:
a photodiode configured to receive the focused light from the lens,
a local oscillator; and
a mixer configured to mix an input light signal received at the detector channel with an output signal from the local oscillator.

17. The device of claim 16, wherein the local oscillator on each of the plurality of detector channels has a power level that is different than power level of the local oscillator of the other of the plurality of detector channels.

18. The device of claim 17, wherein the power of the local oscillator of the detector channels is tapered such that the power level of a local oscillator of the detector channel configured to receive light reflected from an object substantially near the short end of a range of the rotating polygon scanner is lower than the power level of a local oscillator of the detector channel configured to receive light reflected from an object substantially near the far end of the range of the rotating polygon scanner.

19. The device of claim 17, further comprising an electronic switch configured to serially mix output from each of the detector channels with an analog to digital converter (ADC).

20. The device of claim 17, further comprising a plurality of voltage adders wherein each of the plurality of voltage adders is configured to add the output signals related to adjacent detector channels.
